(19) United States
(12) Patent Application Publication
(10) Pub. No.: US 2019/0246858 A1
(43) Pub. Date: Aug. 15, 2019

(54) CLEANING ROBOT WITH ARM AND TOOL RECEPTACLES

(71) Applicants: Nir KARASIKOV, Haifa (IL); Uri Dubin, Haifa (IL)

(72) Inventors: Nir KARASIKOV, Haifa (IL); Uri Dubin, Haifa (IL)

(21) Appl. No.: 15/894,948

(22) Filed: Feb. 13, 2018

(51) Int. Cl. A47L 11/206; A47L 9/28; B25J 11/00; A47L 11/24

(52) U.S. Cl. CPC A47L 11/206; A47L 9/2878; A47L 9/2826; A47L 2201/02; A47L 11/24; A47L 9/2836; B25J 11/0085

(57) ABSTRACT

A cleaning robot includes a propulsion mechanism to propel the robot on a floor, a robotic arm with a gripper at its distal end, and a plurality of different cleaning tools, each cleaning tool including a handle that is configured to be grasped by the gripper. At least one of a plurality of receptacles is configured to hold one of the cleaning tools. A controller is configured to autonomously operate the propulsion system to transport the robot to region to be cleaned, operate the robotic arm to bring the gripper to a receptacle that is holding a selected cleaning tool, operate the gripper to grasp a handle of the selected cleaning tool and to manipulate the cleaning tool when cleaning the region, and operate the robotic arm and the gripper to return the selected cleaning tool to its receptacle.

### FIELD OF THE INVENTION

The present invention relates to cleaning devices. More particularly, the present invention relates to a cleaning robot with an arm and tool receptacles.

### BACKGROUND OF THE INVENTION

Cleaning of a public lavatory facilities and similar facilities (e.g., locker room, shower room, or similar facilities) is usually performed by human janitors and maintenance personnel. This sanitation and maintenance labor force is often classified as unskilled or semi-skilled labor. Generally, except perhaps for floor cleaning, the required tasks are labor intensive and time consuming. Often, effectiveness decreases as personnel become tired or inattentive during the course of a work day. Furthermore, personnel who substitute for regular staff during absence of the latter due to vacation or illness may be unfamiliar with a particular facility. The unfamiliarity may also affect the quality of the cleaning. Such factors may be especially significant to public health where the lavatory facilities are connected to health-providing facilities, such as hospitals and clinics, or to the food preparation industry, e.g., as in a restaurant a food store or plant.

Various devices have been developed to perform specific cleaning tasks. For example, various robots and other devices have been developed to clean floors, clean toilet bowls, and perform other specific cleaning tasks.

Various mobile and self-propelled platforms have been described that include robotic arms that are configured to move various objects from place to place, e.g., in a home, warehouse, restaurant, or other milieu. Various platforms are capable of self-navigation in at least some types of surroundings. Various techniques, including environment sensors, navigation sensors, beacons, fiducials, imaging, and other techniques, have been utilized in navigation.

Various techniques have been described with the ability to change tools or cleaning materials. For example, these include manual replacement of tools (e.g., as in a drill bit or on a vacuum cleaner hose), rotating heads with multiple tools, cartridges with different cleaning fluids, or other techniques.

Some devices may be remotely controlled by a human user via a wireless or wired connection. The human controller may monitor actions of the device from a remote location (which may be within sight of the device). For example, such remotely controlled robots are used by various organizations, such as police, military, and hazardous material handling organizations, e.g., for operation under conditions that could be hazardous to a human.

### SUMMARY OF THE INVENTION

There is thus provided, in accordance with an embodiment of the present invention, a cleaning robot including: a propulsion mechanism to propel the robot on a floor; a robotic arm; a gripper at a distal end of the robotic arm; a plurality of different cleaning tools, each cleaning tool including a handle that is configured to be grasped by the gripper; a plurality of receptacles, at least one of the receptacles configured to hold a cleaning tool of the plurality of cleaning tools; and a controller configured to: autonomously operate the propulsion system to transport the robot to region to be cleaned; operate the robotic arm to bring the gripper to a receptacle of the plurality of receptacles that is holding a selected cleaning tool of the plurality of cleaning tools; operate the gripper to grasp a handle of the selected cleaning tool and to manipulate the cleaning tool when cleaning the region; and operate the robotic arm and the gripper to return the selected cleaning tool to its receptacle.

Furthermore, in accordance with an embodiment of the present invention, the handle is configured to self-align with the gripper when grasped by the gripper.

Furthermore, in accordance with an embodiment of the present invention, the handle has an asymmetric cross section.

Furthermore, in accordance with an embodiment of the present invention, a grip delimiter of the handle is sloped so as to longitudinally center the handle when grasped by the gripper.

Furthermore, in accordance with an embodiment of the present invention, a tool of the plurality of cleaning tools includes an identifying label.

Furthermore, in accordance with an embodiment of the present invention, the identifying label includes an RFID tag, a magnetic strip, barcode, or a visual pattern.

Furthermore, in accordance with an embodiment of the present invention, the gripper includes a sensor configured to read the identifying label.

Furthermore, in accordance with an embodiment of the present invention, the handle of a cleaning tool of said plurality of cleaning tools is uniquely marked with a marking that is distinguishable by an imaging sensor.

Furthermore, in accordance with an embodiment of the present invention, the distinguishable marking is indicative of an orientation of that cleaning tool.

Furthermore, in accordance with an embodiment of the present invention, the cleaning robot includes a plurality of fixed imaging sensors whose fields of view are aimed in different directions.

Furthermore, in accordance with an embodiment of the present invention, at least two fixed imaging sensors of the plurality of fixed imaging sensors have overlapping fields of view.

Furthermore, in accordance with an embodiment of the present invention, the cleaning robot includes an imaging sensor that is placed on the gripper or on the robotic arm.

Furthermore, in accordance with an embodiment of the present invention, the gripper includes a finger with a contact sensor to detect contact of the finger with a surface.

Furthermore, in accordance with an embodiment of the present invention, the controller is further configured to detect the presence of a person.

Furthermore, in accordance with an embodiment of the present invention, the controller is further configured to pause propulsion of the cleaning robot or operation of the robotic arm while the presence of the person is detected.

Furthermore, in accordance with an embodiment of the present invention, a receptacle of the plurality of receptacles is configured to hold a cleaning fluid.

Furthermore, in accordance with an embodiment of the present invention, the controller is further configured to utilize a sensor measurement to compensate for an error in motion of the robotic arm.

Furthermore, in accordance with an embodiment of the present invention, the controller is configured to operate the cleaning robot in accordance with a stored computer aided design (CAD) map of a region.

Furthermore, in accordance with an embodiment of the present invention, the controller is further configured to operate the robotic arm to bring the gripper to an external tool that is not held in the plurality of cleaning receptacles and to operate the gripper to grasp a handle of the external tool and to manipulate the external tool to clean the region.

Furthermore, in accordance with an embodiment of the present invention, the controller is further configured to apply deep learning to sensor data in order to create a map of a region, or to calculate an optimum path for propulsion or for operation of the robotic arm.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a cleaning robot, in accordance with an embodiment of the present invention.

FIG. 2A schematically illustrates an arrangement of four drive wheels of the cleaning robot shown in FIG. 1, aligned to drive the robot in a linear direction.

FIG. 2B schematically illustrates an arrangement of four drive wheels of the cleaning robot shown in FIG. 1, oriented to turn the robot.

FIG. 2C schematically illustrates an arrangement of drive wheels and support wheels on the cleaning robot shown in FIG. 1.

FIG. 3A schematically illustrates a lateral extent of a field of view of a forward-looking sensor of the cleaning robot shown in FIG. 1.

FIG. 3B schematically illustrates a vertical extent of field of view of a forward-looking sensor of the cleaning robot shown in FIG. 1.

FIG. 3C schematically illustrates a lateral coverage by a plurality of imaging sensors of the cleaning robot shown in FIG. 1.

FIG. 3D schematically illustrates vertical coverage by a plurality of imaging sensors of the cleaning robot shown in FIG. 1.

FIG. 4A schematically illustrates a vertical extent of a region that is covered by a gripper sensor of the cleaning robot shown in FIG. 1.

FIG. 4B schematically illustrates a lateral extent of a region that is covered by a gripper sensor of the cleaning robot shown in FIG. 1.

FIG. 5 schematically illustrates a gripper of the cleaning robot shown in FIG. 1.

FIG. 6A schematically illustrates fingers of a gripper of the cleaner robot shown in FIG. 1, prior to grasping a tool handle.

FIG. 6B schematically illustrates the fingers and tool handle of FIG. 6A, with the fingers closed onto the tool handle to grasp the tool handle.

FIG. 7 schematically illustrates a gripper of the cleaning robot of FIG. 1 holding a handle with pyramidal delimiters.

FIG. 8A is a schematic cross-sectional view of a gripper beginning to grasp a tool handle that is misaligned with the gripper.

FIG. 8B is a schematic perspective view of a gripper beginning to grasp a tool handle that is misaligned with the gripper.

FIG. 9A is a schematic cross-sectional view of a gripper grasping a tool handle that is aligned with the gripper.

FIG. 9B is a schematic perspective view of a gripper grasping a tool handle that is aligned with the gripper.

FIG. 10A schematically illustrates the cleaning robot of FIG. 1 grasping and manipulating a cleaning tool.

FIG. 10B schematically illustrates the cleaning robot of FIG. 1 accessing a cleaning tool in a receptacle.

FIG. 11 is a schematic block diagram of an example of controller architecture for the cleaning robot shown in FIG. 1.

FIG. 12 schematic illustrates planning a path for cleaning lavatory facilities by the cleaning robot shown in FIG. 1.

FIG. 13 schematically illustrates a toilet lid that is configured for operation by the cleaning robot shown in FIG. 1.

FIG. 14 is a flowchart depicting a method for cleaning by a cleaning robot, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a mobile cleaning robot is configured to perform a variety of cleaning tasks, e.g., in a lavatory facility. The cleaning robot includes a multiple-jointed arm with a gripper at its distal end, and a plurality of receptacles. The receptacles are configured to hold a plurality of tools and cleaning substances. The gripper enables the robotic arm to perform a variety of manipulating and grasping tasks. These tasks include removing a tool from one of the receptacles and manipulating the tool to clean various types of surfaces and fixtures. The tasks may also include manipulation of various external objects such as handles, doors, and lids.

The cleaning robot includes a rechargeable battery for powering the various functions of the robot, including a propulsion system, the robotic arm, and a control system.

The propulsion system is configured to propel the cleaning robot over a floor at a controlled speed and in a controlled direction. The propulsion system typically includes one or more motors operating one or more drive wheels that enable propulsion over a substantially flat surface (e.g., which may be gently sloping or may include some small variations in height, e.g., at a door threshold). In some cases, the propulsion system may include one or more tracks to enable climbing or descending over taller obstacles, such as a step or staircase.

One or more of the drive wheels may be steerable to enable or facilitate steering and turning of the robot. Alternatively or in addition, two or more drive wheels may be arranged such that driving the drive wheels at different speeds may provide a turning torque that enables or facilitates steering and turning of the robot. This includes rotating in opposing directions to facilitate rotation with a rotary motion.

A control system may be configured to autonomously control operation of the propulsion system and of the robotic arm. The control system may be configured to receive information from one or more sensors regarding the current status of various systems of the robot, as well as information regarding a current location and environment of the robot. The control system may include one or more data processors that are configured to operate in accordance with programmed instructions. The control system may include provision for convolutional neural networks (CNN) and deep learning (DL). The control system may include or communicate with a data storage system that includes stored instructions and parameters. The stored information may include a map or layout of a region within which the cleaning robot is expected to operate, e.g., in the form of a computer-aided design (CAD) model, or otherwise. The control system, based on the sensor-based information and stored information, may control operation of the propulsion system and of the robotic arm.

In some cases, the control system of the cleaning robot may be configured to utilize deep neural network, DL, and other machine learning techniques to assist in identifying and determining the locations of various objects that are sensed by the sensors. In some cases, sensor data from the cleaning robot may be transmitted to an external (to the cleaning robot) or remote control station, e.g., for review or supervision by a human operator.

The cleaning robot may be configured to perform a variety of cleaning tasks in different environments. The environments may include lavatory facilities, and parts of residences, offices, and other types of indoor facilities that have predictable or constant surroundings and that may be mapped in advanced (e.g., where fixtures are, at least for the most part, fixed within a room).

The robotic arm enables the cleaning robot to be adapted to a variety of room layouts and fixtures. For example, in a lavatory, the robotic arm may be programed to clean various types of fixtures such as toilet bowls, toilet seats, urinals, sinks, and other fixtures, as well as floors and walls. The robotic arm may also be configured to open doors, pick up objects from the floor or other surfaces, measure the distance to surrounding objects, or perform other actions.

A proximal end of the robotic arm is connected to the body of the robot. The connection to the cleaning robot may enable at least limited rotation relative to the cleaning robot body. A distal end of the robotic arm terminates in a gripper. The robotic arm includes a plurality of segments between its proximal and distal ends. Pairs of adjacent segments are connected to one another by powered joints. At least some of the joints may be controlled to bend by a controllable amount, thus laterally rotating one of the segments connected by a joint relative to the other adjacent segment. One or more of the joints may be controlled to axially rotate one segment relative to the adjacent segment to which it is connected by that joint.

The plurality of joints may enable manipulation of the gripper to a wide range of locations on, and in the vicinity of, the robot. The gripper is provided with a plurality of manipulable, e.g., bendable, fingers. For example, two fingers may extend distally from one side of the gripper, and an opposing finger may extend distally from the opposite side of the gripper. In this example, the fingers may be bent inward about an object in order to grasp the object. Additional fingers may enable a firmer or stronger grasp. For example, the gripper may be manipulated to grasp, manipulate, and release a handle or other part of a cleaning tool.

The robotic arm and its gripper may be configured to function similarly to a human hand. Thus, the robotic arm may be manipulated to perform many functions that a human could perform using a single hand. For example, the cleaning robot may be programmed to use tools that were not designed specifically for use with the robot. Such tools may include a hose or handle of a vacuum cleaner, a water hose, or other tools or equipment. On the other hand, the multiply-jointed robotic arm may be longer and more flexible than a human arm. Furthermore, one or more sensors may be mounted at the distal end of the robotic arm. Thus, the cleaning robot may be capable of manipulating a tool in places that are not readily reached by a human. Such places may include, for example, narrow spaces next to or behind a toilet bowl, spaces under sinks or countertops, spaces below work tables or heavy machinery (e.g., on industrial floors), or other spaces.

Tools may be designed to facilitate identification and handling by the cleaning robot. For example, a tool may be provided with a handle that is configured to be held firmly by the gripper of the cleaning robot. The tools may be provided with a label that enables or facilitates identification of the tool by the cleaning robot. For example, a tool may be provided with a bar code, radiofrequency identification (RFID) tag, magnetic coding, or a distinguishing shape or contour that enables or facilitates automatic identification of the tool.

The cleaning robot may include receptacles for holding the tools. A receptacle may be configured to hold a particular tool or may be suited for holding a variety of tools.

The cleaning robot may include one or more sensors that enable effective performance of cleaning tasks. For example, sensors may be located on the body of the cleaning robot or on the arm. Rangefinder, stereoscopic, or other sensors may measure a distance to objects or surfaces and may assist with navigation. Imaging sensors may enable evaluation or recognition of objects and surfaces as well as derive three-dimensional (3D) information. The robot may contain ultraviolet lamps and sensors to detect dirty or uncleaned areas that are covered by fluorescent substances.

Imaging sensors that are located on the robotic arm may enable detailed viewing of an object or surface. Proximity sensors and force or touch sensors may enable precise measurement of applied forces. Thus, the sensors on the arm may facilitate precise handling and treatment of objects and surfaces and may enable avoidance of damage to objects and surfaces. Use of sensors for precise measurement may, in some cases, enable compensation for errors by motors, actuators, or other mechanical components, thus enabling the use of a less expensive robot comprising less accurate motors and components than may be otherwise required (e.g., backlash-free operation).

Information from the various imaging, proximity, and other sensors may be analyzed to enable determination of a position and orientation of the cleaning robot or robotic arm relative to its surroundings. A controller of the cleaning robot may apply one or more computer vision or other techniques to identify and to determine distances to various objects and surfaces in the surroundings. Similarly, application of the techniques may enable detection of humans in the vicinity of the cleaning robot or robotic arm. The cleaning robot may be configured to cease or limit operation when a human is detected within a workspace of the robot.

Autonomous operation of the cleaning robot may rely on previous mapping of the workspace and work environment of the robot. A controller of the cleaning robot may have access to a database that includes a precise description of the dimensions and layout of a room or other workspace in which the cleaning robot is expected to operate autonomously. The database may also include information regarding moving parts, such as doors, handles, toilet seats and covers, covers to receptacles, cabinet doors and drawers, movable furniture, other objects. The mapping may be performed by the cleaning robot itself, e.g., in a learning or exploring mode, or may be entered externally. In one configuration, dedicated CAD may describe the building, as when placing new furniture in an apartment.

The cleaning robot may communicate with a remote central database, e.g., via a wireless network or otherwise. The central database may include information that is collected from a fleet of robots and may control the robots (e.g., subject to intervention by a human operator).

The diverse capabilities of the cleaning robot may enable a single robot, or type of robot, to perform a wide variety of cleaning tasks. Thus, a single cleaning robot may suffice for a single facility or cleaning service. A single type of cleaning robot may be manufactured that may be adapted for use by many different operators of facilities or providers of cleaning services. Specific needs of different users may be accommodated by programming (e.g., by the user or by a provider of the cleaning robot), without requiring customized hardware. This allows using a generic robotic platform, having the required degrees of freedom and adding on top of it sensors, grippers and logic.

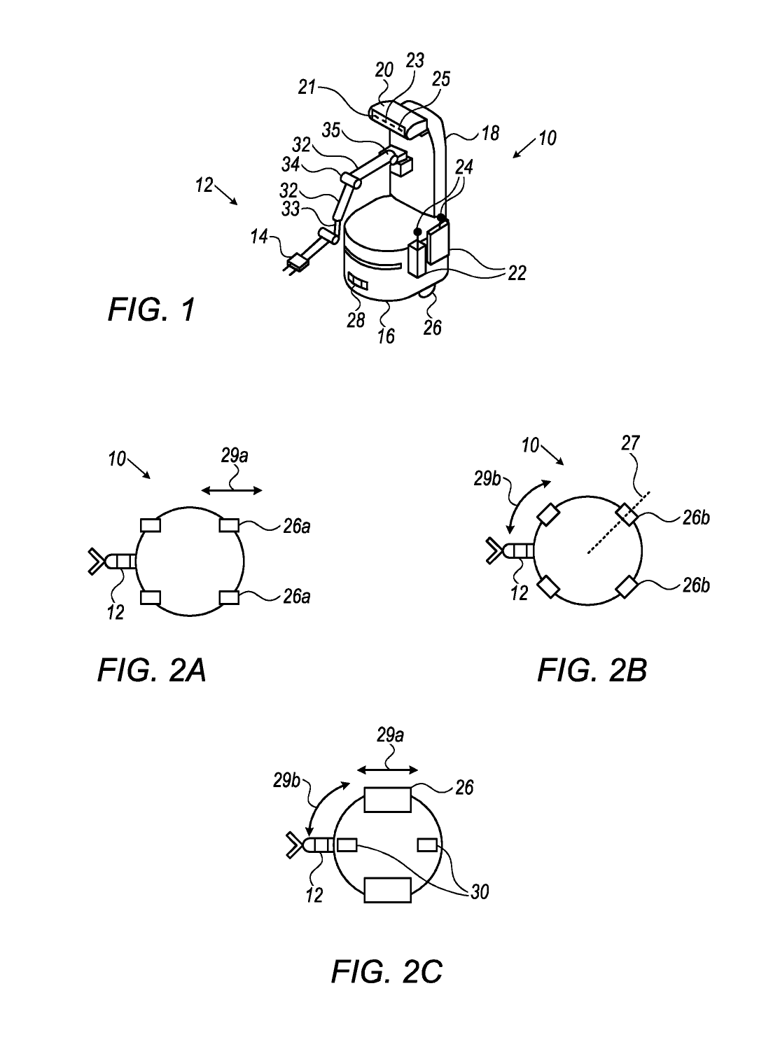

FIG. 1 schematically illustrates a cleaning robot, in accordance with an embodiment of the present invention.

Cleaning robot 10 includes robotic arm 12 to enable cleaning robot 10 to perform a plurality of tasks.

A proximal end of robotic arm 12 may be connected to arm base 18. Arm base 18 may include one or more mechanical or electrical mechanisms that enable control of robotic arm 12. A distal end of robotic arm 12 may terminate or include gripper 14. For example, gripper 14 may include a plurality of manipulable fingers or extensions that may be operated to grip an object.

Robotic arm 12 includes a plurality of arm segments 32 connected by arm joints 34. Each arm joint 34 may be controllable to bend so as to change a relative orientation of two arm segments 32 that are connected at that arm joint 34 to a predetermined angle. The angle may be determined by programming of cleaning robot 10. The programming may control arm joints 34 in accordance with sensed conditions and in accordance with a programmed task. In addition, an arm connection 35 of robotic arm 12 to arm base 18 may enable rotation of robotic arm 12 relative to arm base 18, e.g., about one or two axes. In some cases, one or more rotatable arm joints 33 may be configured such that an arm segment 32 that is connected rotatable arm joint 33 may be rotated axially (e.g., about an axis of that arm segment 32, or about an axis parallel to the axis of that arm segment 32) relative to the other arm segment 32 that is connected to rotatable arm joint 33.

Configuration of robotic arm 12 with multiple arm segments 32 (e.g., typically more than in a human arm) may enable robotic arm 12 to be folded into a configuration with minimal volume (e.g., such that robotic arm 12 does not extend laterally outward beyond the perimeter of robot base 16). The minimal volume configuration may enable movement of cleaning robot 10 through narrow doorways or passageways reduced risk of collision between robotic arm 12 and a doorframe or passageway walls.

Robotic arm 12 may be configured to mimic the functionality of the human arm with the latter's multiple degrees of freedom. For example, motion of robotic arm 12 may be possible in six or seven degrees of freedom (not all independent). Human arm functionality to be mimicked may include opening doors and manipulating a cleaning tool 24 in a manner that mimics human use of a similar tool. The distal end of robotic arm 12 may be configured to reach a floor on which cleaning robot 10 is standing. Arm connection 35 may enable lateral rotation of the distal end of robotic arm 12 to the right or left. Robotic arm 12 may be configured to support the weight of a mass of typically 5 kg or more. The mass of robotic arm 12 may be minimal such that the center of gravity of cleaning robot 10 remains within the footprint of robot base 16.

The proximal end of robotic arm 12 may connect to arm base 18 at a height that is designed to enable manipulation of robotic arm 12 and of gripper 14 to any location within a predetermined range of cleaning robot 10. For example, the range may extend vertically from the floor to a maximum height. The maximum height may correspond to an expected height of the highest fixture or wall (or ceiling) that cleaning robot 10 is expected to clean. A lateral range may be selected to enable gripper 14 to be manipulable to reach all points within a designed radius of cleaning robot 10. The lateral range may vary with height and azimuth (e.g., relative to arm base 18) of gripper 14. Since cleaning robot 10 is self-propelled, cleaning robot 10 may be configured to move in order to enable manipulation of gripper 14 to a point that is outside of the designed radius.

Gripper 14 may include a plurality of fingers or projections that may be manipulated to firmly grasp an object. After the object is grasped, robotic arm 12 may be controlled so as to move or manipulate the grasped objected to a controllable position or to move the object in a controllable manner.

Robot base 16 may include one or more components to enable operation of cleaning robot 10. For example, robot base 16 may enclose a propulsion system that may be operated to enable self-propulsion of cleaning robot 10. The propulsion system may include one or more propulsion motors that may be configured to operate one or more drive wheels 26. For example, each drive wheel 26 may be operated by a separate motor, e.g., via a separate transmission assembly. As another example, a single motor may be connected via a transmission to two or more drive wheels 26. In some cases, drive wheels 26 may include tracks or other structure to facilitate traction between drive wheels 26 and a floor or other surface over which cleaning robot 10 is to be propelled. In some cases, additional wheels or supports may be provided to increase stability of robot base 16 and of cleaning robot 10.

In some cases, a steering mechanism may laterally pivot each drive wheel 26 about a vertical axis. Thus, an orientation of rotation of each drive wheel 26 may be changed in order to steer cleaning robot 10. In some cases, an orientation of each drive wheel 26 (e.g., no more than two drive wheels 26) may be fixed (e.g., cannot pivot), with steering effected by applying different torques to different drive wheels 26.

FIG. 2A schematically illustrates an arrangement of four drive wheels of the cleaning robot shown in FIG. 1, aligned to drive the robot in a linear direction.

In the example shown, four drive wheels 26a are arranged parallel to one another. Thus, application of a torque to drive wheels 26a may propel cleaning robot 10 with a translational motion parallel to linear direction 29a.

FIG. 2B schematically illustrates an arrangement of four drive wheels of the cleaning robot shown in FIG. 1, oriented to turn the robot.

In the example shown, each drive wheel 26b is oriented such that its axis of rotation lies along a radius 27 through the axis of that drive wheel 26b. Thus, application of torque in a single direction (relative to its axis) to all of drive wheels 26b may cause cleaning robot 10 to turn or rotate as indicated by rotation direction 29b, with no translational motion of cleaning robot 10.

FIG. 2C schematically illustrates an arrangement of drive wheels and support wheels on the cleaning robot shown in FIG. 1.

In the example shown, cleaning robot 10 includes two drive wheels 26 and two support wheels 30. Support wheels 30 are not connected to a motor or drive mechanism, but are enabled to rotate freely when drive wheels 26 propel cleaning robot 10. In some cases, support wheels 30 may be configured to swivel or pivot freely, e.g., in response to turning of cleaning robot 10.

Drive wheels 26, when rotated in tandem (e.g., at a common speed in a common absolute direction of rotation), may propel cleaning robot 10 with a translational motion parallel to linear direction 29a. Rotation of drive wheels 26 at a common speed but in opposite directions (e.g., a common direction relative to a local radius through each drive wheel 26) may cause cleaning robot 10 to turn or rotate as indicated by rotation direction 29b, with no translational motion of cleaning robot 10. Support wheels 30 may provided sufficient support so as to prevent cleaning robot 10 from tipping over.

Robot base 16 may be configured to stably support cleaning robot 10. For example, a lateral extent (e.g., width or diameter) of robot base 16 may be sufficiently large to ensure that a center of gravity of cleaning robot 10 remains within lateral boundaries of robot base 16 (e.g., is always surrounded by a sufficient number of drive wheels 26 or other supports of robot base 16) so as to prevent tipping of cleaning robot 10. The mass of robot base 16 may also be sufficient to function as a counterweight to robotic arm 12 (e.g., when holding a predetermined maximum weight at a maximum distance from robot base 16) so as to ensure that the center of gravity of cleaning robot 10 remains within the lateral boundaries of robot base 16.

Robot base 16 may include a storage battery or other type of rechargeable source of electrical power to provide power for operation of various components of cleaning robot 10. Robot base 16 may include charging connection 28 for connecting the rechargeable battery to a wall socket or other external source of power. For example, charging connection 28 may include a male (plug) or female (socket) connector at the end of an extendible and retractable cord or rod to connect with mating structure on a wall socket or charging station. As another example, charging connection 28 may include a male (plug) or female (socket) connector that is connectable to mating structure at the end of a cord or rod that is extendible from a fixed charging station. Alternatively or in addition, charging connection 28 may be located on arm base 18 or elsewhere on cleaning robot 10.

Robot base 16 may include one or more receptacles 22. For example, a receptacle 22 may be configured to a hold a cleaning tool 24, a part (e.g., a replaceable part) of a cleaning tool 24, a cleaning substance (e.g., powder, gel, or liquid), waste (e.g., objects or substances that are removed as part of cleaning of an area), or another object or substance. For example, a receptacle 22 may be shaped to conveniently and sanitarily hold a particular cleaning tool 24. In some cases, e.g., for a cleaning tool 24 that is configured to function as a mop, toilet brush, or similar function, a receptacle 22 for that cleaning tool 24 may be configured to be filled with a cleaning fluid. Thus, when that cleaning tool 24 is removed from its corresponding receptacle 22, the cleaning may be already saturated or wetted with an appropriate cleaning fluid. Replacing that cleaning tool 24 in its receptacle 22 after use may replenish the cleaning fluid on that cleaning tool 24. Where several fluids are to be applied sequentially by cleaning tool 24, the cleaning tool 24 may be inserted into a receptacle 22 with the appropriate cleaning fluid at each stage, or use may be made of mops that are designed with advanced microfiber materials that can contain fluids inside.

Robotic arm 12 may be controllable to manipulate gripper 14 to one or more receptacles 22. For example, gripper 14 may be manipulable to remove a cleaning tool 24 from receptacle 22, to place a cleaning tool 24 into a receptacle 22, or to remove from receptacle 22 or place into receptacle 22 another type of object or substance.

A receptacle 22 may be configured to hold a particular cleaning tool 24 or may be configured to hold any cleaning tool 24 or any cleaning tool 24 in a family of similar cleanings tools 24. A receptacle 22 may be replaceable, e.g., for maintenance purposes or to enable holding of a different cleaning tool 24. A single replaceable receptacle 22 may be configured to concurrently hold a plurality of cleaning tools 24. A size or location of receptacle 22 may be configured so as not to interfere with operation or movement of cleaning robot 10.

Cleaning robot 10 includes one or more sensors 21. For example, sensors 21 may be located one or more of control unit 20 (as in the example shown), on robot base 16, on arm base 18, on robotic arm 12, on gripper 14, or elsewhere in cleaning robot 10. Sensors 21 may enable one or more of detection of objects, fixtures, and surfaces, measuring locations (e.g., distance and direction) of objects, fixtures, and surfaces, and evaluating objects, fixtures, and surfaces. For example, proximity or contact sensor may sense proximity of an object, fixture, or surface or contact with an object, fixture, or surface.

Sensors 21 may include, for example, one or more of video cameras in one or more spectral ranges (e.g., visible, infrared, ultraviolet), rangefinders (e.g., based on optical, acoustic, electromagnetic, or other techniques, e.g., lidar, sonar, or radar), proximity sensors (e.g., acoustic, optic, or electromagnetic), inertial measurement unit (IMU), tilt sensors, accelerometers, orientation sensors (e.g., compass or gyroscope), contact sensors (e.g., mechanical, strain, or piezoelectric touch, pressure, or force sensors, e.g., located on robot base 16, on robotic arm 12 or on gripper 14), encoders or other rotation or angle sensors (e.g., for measuring a bending angle of an arm joint 34, or a rotation of a drive wheel 26 or of a rotatable arm joint 36), position sensors (e.g., relative to a local, regional, or global coordinate system), or other sensors.

One or more of sensors 21 may be calibrated by applying a calibration procedure. For example, during a calibration procedure, a sensor 21 in the form of a camera may acquire images of a known pattern when viewed from one or more known positions and orientations. A calibration procedure of a sensor in the form of a rangefinder, proximity sensor, or force sensor, may include acquiring measurements on surfaces or objects at known distances, or when a known force is applied.

Sensed data from sensors 21 may be analyzed to yield one or more of a location of an objects, fixture, surface, or structure. The analysis may enable detection of, and measurement of a location of, a surface requiring cleaning, a foreign object that is to be removed, an object (e.g., a cleaning tool 24 or other object) that is to be manipulated by gripper 14 or robotic arm 12, an obstacle to be avoided, or a person. The analysis may identify a status of a door, handle, or other object or fixture, or another sensed characteristic or situation. The analysis may yield a current status or location of cleaning robot 10, robotic arm 12, or gripper 14. A location of cleaning robot 10 may be determined relative to a local coordinate system (e.g., room plan or map, relative to a local marker, fiducial, fixture, or beacon), a regional coordinate system (e.g., a plan of a building or campus), or global coordinate system (e.g., latitude, longitude, altitude, Global Positioning System (GPS) or other satellite-based coordinate system), or otherwise.

One or more sensors 21 may be configured to map the locations of objects within a predetermined region. Such sensors may include, for example, a pair of boresighted video cameras (e.g., recording red-green-blue (RGB) or monochrome images, or other video formats), a video camera with distance measurement (RGB-D), lidar, radar, or another type of three-dimensional mapping.

One or more sensors 21 may be configured to map a region that is fixed relative to cleaning robot 10 (e.g., within a constant distance range of, and on a constant side of, cleaning robot 10). For example, one or more sensors 21 (e.g., located on control unit 20) may be a forward-looking sensor configured to map a region that is in front of cleaning robot 10.

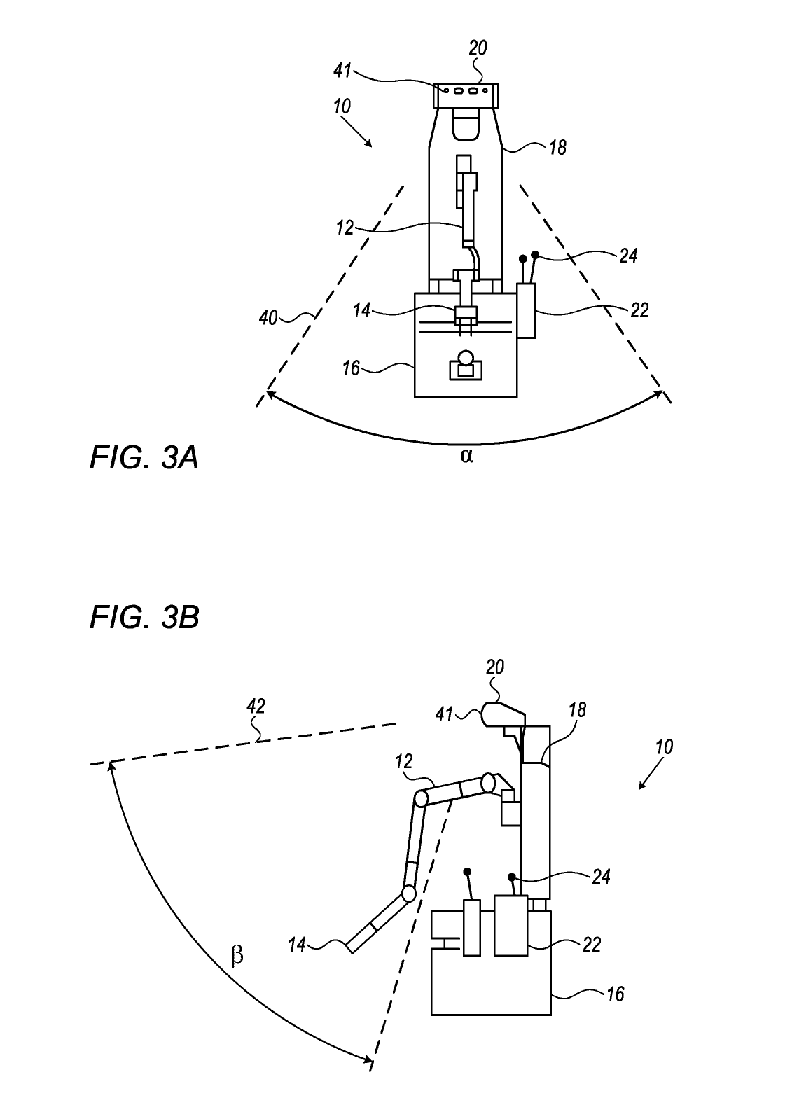

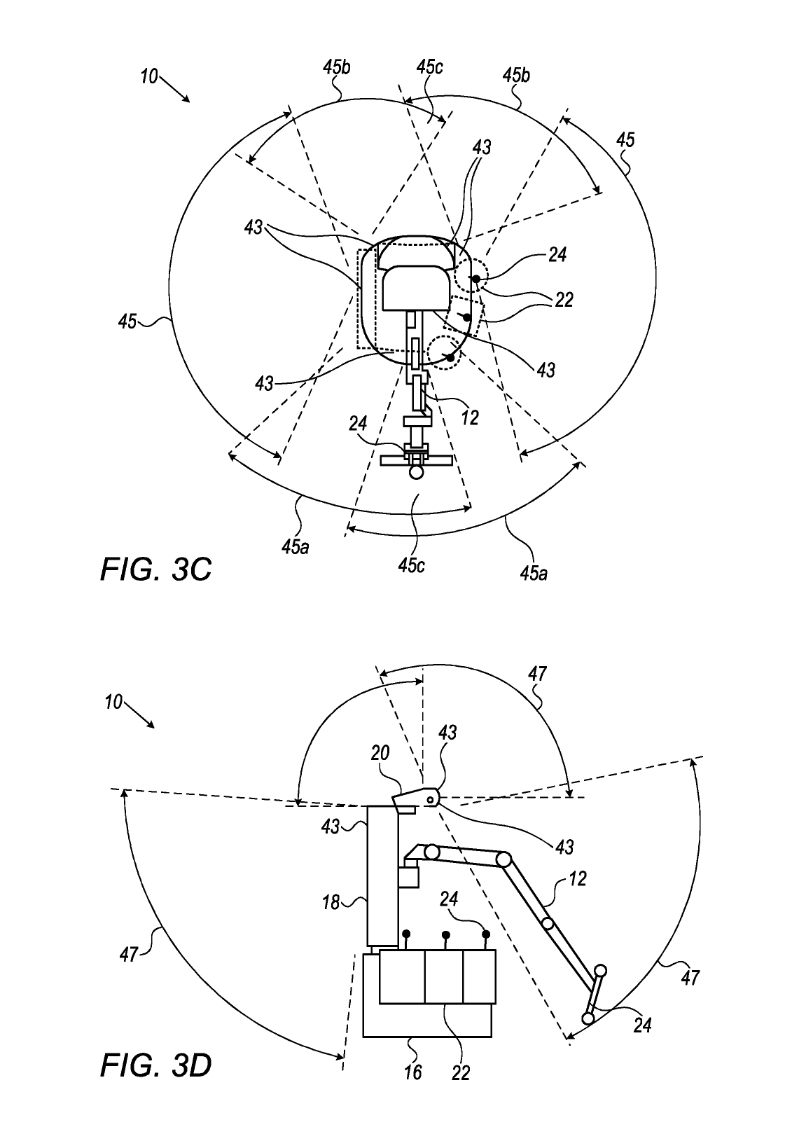

FIG. 3A schematically illustrates a lateral extent of a field of view of a forward-looking sensor of the cleaning robot shown in FIG. 1. FIG. 3B schematically illustrates a vertical extent of field of view of a forward-looking sensor of the cleaning robot shown in FIG. 1.

In the example shown, a lateral extent 40 of a region covered by a sensor 21 in the form of forward-looking imaging sensor 41 is characterized by an angle α (e.g., about 65° or other range). A vertical extent 42 of a region covered by forward-looking imaging sensor 41 is characterized by an angle β (e.g., about 65° or other range). For example, sizes of lateral extent 40 and vertical extent 42 may be selected to cover areas near robot base 16. The sizes of lateral extent 40 and vertical extent 42 may be selected to cover a region ahead of robot base 16 when cleaning robot 10 is traveling in a forward direction. For example, data from forward-looking imaging sensor 41 may facilitate location of objects to be removed or obstacles to be avoided, determining a position of robotic arm 12 or of gripper 14, evaluation a quality (e.g., cleanliness) of a surface, or acquiring other information.

Sensors similar to forward-looking imaging sensor 41 may be configured to acquire similar information on other sides of cleaning robot 10. For example, such similar sensors may facilitate operation within small spaces, detecting people in the vicinity of cleaning robot 10, or in acquiring other information about the surroundings of cleaning robot 10.

Imaging sensors may be configured to view other directions. In some cases, the fields of view of different imaging sensors may be aimed to overlap or abut such that the field of view covers all of the surroundings (e.g., an entire angular hemisphere) of cleaning robot 10.

FIG. 3C schematically illustrates a lateral coverage by a plurality of imaging sensors of the cleaning robot shown in FIG. 1. FIG. 3D schematically illustrates vertical coverage by a plurality of imaging sensors of the cleaning robot shown in FIG. 1.

In the example shown, cleaning robot 10 includes a plurality of fixed imaging sensors 43 that are each aimed in a different direction.

For example, lateral fields-of-view 45 of different fixed imaging sensors 43 cover different sides, including front, back, right, and left sides. In the example shown, lateral fields-of-view 45 provide complete 360° azimuthal coverage. In the example shown, lateral fields-of-view 45a in the forward direction overlap, as do lateral fields-of-view 45b in the backward direction, enabling binocular vision in overlap regions 45c.

In the example shown, vertical fields-of-view 47 provide complete altitude coverage from the floor to the zenith.

Sensors similar to forward-looking imaging sensor 41 may be mounted elsewhere on cleaning robot 10. For example, the imaging sensors may be mounted on gripper 14 or on robotic arm 12 near gripper 14.

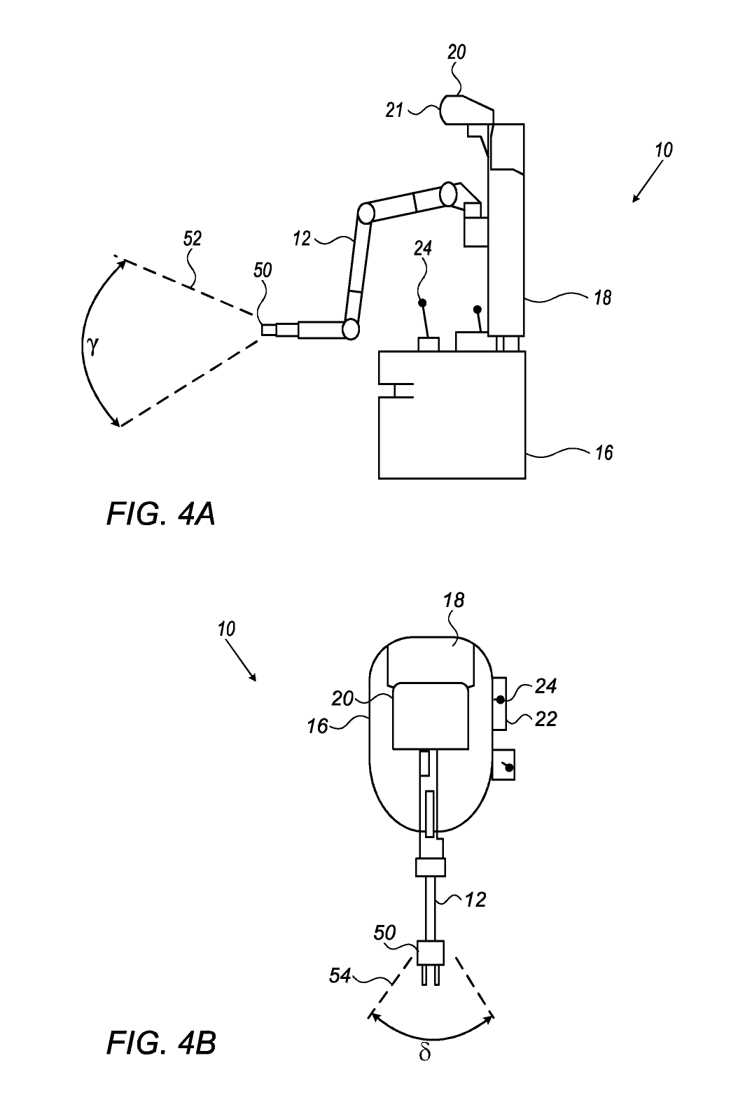

FIG. 4A schematically illustrates a vertical extent of a region that is covered by a gripper sensor of the cleaning robot shown in FIG. 1. FIG. 4B schematically illustrates a lateral extent of a region that is covered by a gripper sensor of the cleaning robot shown in FIG. 1.

In the example shown, a vertical extent 52 of a region imaged by a sensor 21 in the form of gripper-view imaging sensor 50 is characterized by an angle γ (e.g., about 70° or other range). A lateral extent 54 of a region covered by gripper-view imaging sensor 50 is characterized by an angle δ (e.g., about 65°, or another range). For example, sizes of vertical extent 52 and lateral extent 54 may be selected to objects near gripper 14 that may be grasped by gripper 14. Gripper-view imaging sensor 50 may be utilized to evaluate areas or surfaces that are hidden from forward-looking imaging sensor 41 (e.g., by intervening objects or structures).

Control unit 20 is used herein to represent any component that is utilized in controlling operation of cleaning robot 10 and should not be understood as representing a particular physical unit or location on cleaning robot 10.

Control unit 20 may include one or more lamps, or other illumination sources to enable illumination of a region to be cleaned. For example, an illumination source may be operated when ambient lighting is inadequate, or to provide lighting in a particular spectral range (e.g., in order to facilitate evaluation of a surface).

Control unit 20 may include one or more processing units, memory or data storage devices, communications devices, controllers, or other components. Control unit 20 may be located near the top of cleaning robot 10, as shown, or may be located elsewhere on cleaning robot 10. In some cases, components or functionality of control unit 20 may be distributed among two or more controllers or processing units that are located in various locations on cleaning robot 10. In some cases, at least some functionality of control unit 20 may be located on a component or device that is located at a location that is remote to cleaning robot 10. For example, such a remote component or device may include a processing unit or controller that is located in a portable control unit (e.g., in a remote control unit, or on a smartphone or other portable device that is configured to execute an appropriate control application), in a remote control station or server (e.g., in communication with control unit 20 or cleaning robot 10 via a wired or wireless connection, or via a network), or elsewhere. Communication capability of a component of control unit 20 that is located on cleaning robot 10 may enable communication with the remote component or device.

Control unit 20 may be configured to store a three-dimensional model, map, or plan of a room in which cleaning robot 10 is to operate (e.g., a lavatory facility). In some cases, control unit 20 may be configured to create the model, map, or plan. A CAD application of a building interior description is one approach to provide the robot with the structure and layout of the cleaning area. In some cases, the room may be configured to facilitate operation of cleaning robot 10. For example, the room may be designed so as to facilitate efficient cleaning by cleaning robot 10, e.g., by being provided with fixtures (e.g., handles, toilet lids, and other fixtures) that are designed to facilitate access by cleaning robot 10 and by robotic arm 12. A layout of the room may be configured to facilitate access to all surfaces and fixtures that are to be cleaned by cleaning robot 10. The room may be provided with markers and signals that facilitate navigation by cleaning robot 10.

Control unit 20 may be configured to analyze image data that is acquired by one or more sensors 21 to calculate a distance to an object or surface. For example, a distance may be calculated using two imaging sensors that are boresighted or otherwise aligned (binocular vision) to estimate a distance depth from binocular vision using parallax or multiple-view geometry. If an imaging sensor is moved in a controlled and known manner, two sequentially acquired views may be compared to calculate the distance to an imaged object or surface.

Control unit 20 may be configured to communicate with a remote control station. For example, the control station may monitor operation of one or more cleaning robots 10. The control station may be configured to enable a human operator to take control of cleaning robot 10 (e.g., in the event of a detected situation for which cleaning robot 10 was not programmed to handle).

Control unit 20 may be configured to communicate with a remote server, e.g., via wireless connection (e.g., Wi-Fi, General Packet Radio Service (GPRS), or another wireless connection). The server may be configured to collect, store, or process sensed or operation data from one or more cleaning robots 10. The processed data may be utilized to transmit revised programming to one or more cleaning robots 10, e.g., in order to improve operation in light of new data or new situations.

Control unit 20 may include one or more user controls 25 (e.g., pushbutton, touch screen, switch, keyboard, keypad, knob, pointing device, microphone, or other user operable control) to enable a human operator to manually control one or more operations of cleaning robot 10. For example, user controls 25 may enable the operator to turn electrical power to cleaning robot 10 on or off, to abort, pause, or start an operation, or otherwise control operation. User controls 25 may enable an operator to disable autonomous operation of cleaning robot 10 in case of an emergency situation (e.g., a panic or abort button or switch) in order to manually transport cleaning robot 10 to another room (e.g., using a handle that is attached to arm base 18, robot base 16, or elsewhere on cleaning robot 10 in FIG. 1). Some or all of user controls may be located on arm base 18, on robot base 16, on robotic arm 12, or elsewhere on cleaning robot 10. One or more user controls 25 may be located on a portable or stationary remote unit.

Control unit 20 may include one or more output devices 23 in the form of displays, indicator lights, speakers, alarms, or other output devices to notify a human operator of a current status (e.g., presence or absence of one or more cleaning tools 24, current supply of one or more cleaning substances, status of one or more waste containers, status of power supply, warning of possible hazardous or other undesirable situation, or other data related to status).

Cleaning robot 10 may be configured to operate in a manner similar to human maintenance personnel. For example, cleaning robot 10 may be configured to clean a floor by grasping a cleaning tool 24 in the form of a mopping tool with gripper 14, and operating drive wheel 26 and robotic arm 12 to place an end of the mopping tool on the floor and to move the tool across the floor in an efficient or otherwise predetermined pattern. Cleaning robot 10 may be configured to clean a toilet bowl by lifting a toilet lid and seat, grasping a cleaning tool 24 in the form of a toilet brush tool with gripper 14 and removing the toilet brush tool from a receptacle 22, moving the end of the toilet brush tool in a predetermined pattern around the interior of the toilet bowl, replacing the toilet brush tool in receptacle 22, and lowering the toilet seat and closing the toilet lid. With the toilet seat closed, gripper 14 may grasp a cleaning tool 24 in the form of a toilet seat cleaner to clean the upper surface of the toilet seat. Similar specialized cleaning tools 24 may be manipulated to clean urinals, sinks, walls, doors, or other fixtures or surfaces. Cleaning robot 10 may be configured to dispense a cleaning fluid or other substance from an appropriate receptacle 22, or may be configured to manipulate a cleaning tool 24 to a receptacle 22 containing an appropriate cleaning substance before applying that cleaning tool 24 to a surface or fixture that is to be cleaned.

Dimensions of components of cleaning robot 10 may be configured specially to enable cleaning of a public lavatory facility. For example, gripper 14 may be configured to reach a minimum height of 1 meter to 1.5 meter above floor (e.g., sufficient to reach walls, sinks, and mirrors), the width of robot base 16 may not exceed 0.5 meter to 0.6 meter (e.g., in order to enable access to narrow passageways), and minimum mass of 35 kg to about 55 kg with low center of gravity (e.g., in order to provide sufficient stability). Robotic arm 12 may be configured to provide a force of up to 50 newtons, or another maximum force. Other ranges or values may be used.

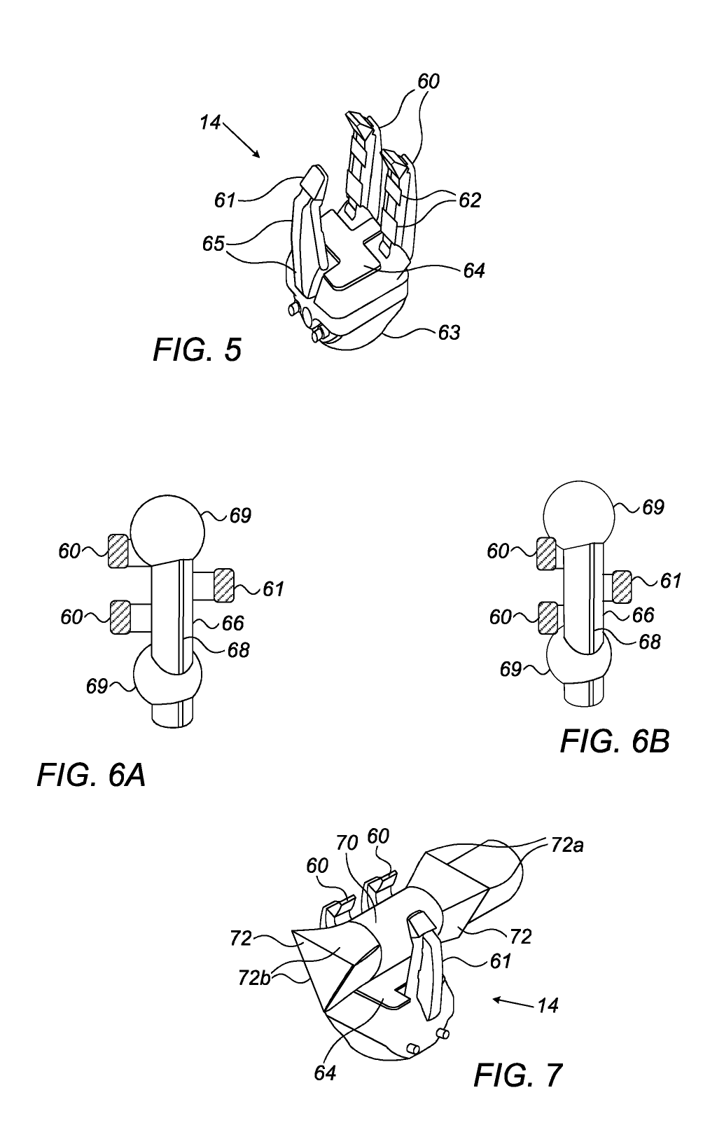

FIG. 5 schematically illustrates a gripper of the cleaning robot shown in FIG. 1.

Gripper 14 may be configured to attach to robotic arm 12 at wrist joint 63. Wrist joint 63 may enable at least limited axial rotation of gripper 14 relative to robotic arm 12 (similar to axial rotation of a human hand about the axis of a human forearm). For example, the axial rotation may be limited to about ±90° from a nominal axial orientation, or to another angular range.

In the example shown, gripper 14 includes at least three fingers, at two gripper fingers 60 on one side of gripper 14 and opposing gripper finger 61 on the opposite side of gripper 14. Each gripper finger 60 and opposing gripper finger 61 is configured with one or more jointed finger segments 65 that are configured to bend relative to one another. The relative bending of jointed finger segments 65 may enable each gripper finger 60 or opposing gripper finger 61 to bend inward (flex inward) from an extended state (e.g., in a manner similar to flexing of a human finger). An interface between two jointed finger segments 65 may be provided with an encoder or other device form measuring a bending angle between adjacent jointed finger segments 65.

Thus, gripper fingers 60, opposing gripper finger 61, or both may be flexed inward toward one another in order to grasp an object in a firm and stable manner. Each gripper finger 60 and opposing gripper finger 61 may be manipulated separately to flex inward or extend outward. For example, each gripper finger 60 or opposing gripper finger 61 may be flexed to apply a maximum force of 20 newtons, or another maximum force.

In some cases, a gripper 14 may include more than two gripper fingers 60 and more than one opposing gripper finger 61. In some cases, two gripper fingers 60 may be replaced by a single wide finger. A distal tip of each gripper finger 60 or opposing gripper finger 61 may include structure (e.g., a rubber-like material with high friction, ridges, grooves, or other structure) to facilitate handling and grasping of thin or other objects that would otherwise be difficult to grasp.

Each gripper finger 60 and opposing gripper finger 61 is provided with one or more finger contact sensors 62 to enable sensing of contact of a finger surface with an object surface. For example, in the example shown, each finger segment 65 is provided with a separate finger contact sensor 62. Finger contact sensors 62 may be otherwise distributed. Gripper 14 may also include one or more palm sensors 64 in a region of gripper 14 between gripper fingers 60 and opposing gripper finger 61 (e.g., in a region corresponding to the palm of a human hand).

For example, each finger contact sensor 62 may include a force sensor or other type of sensor to verify mechanical contact between finger contact sensor 62 and an object surface. In some cases, finger contact sensor 62 may provide a quantitative measurement of a contact force between one or more parts of gripper 14 and an object surface.

A finger contact sensor 62 or palm sensor 64 may include a proximity sensor to detect the proximity of a surface of an object, fixture, structure or other surface. A palm sensor 64 may include a sensor for detecting an identifying tag or label of an object (e.g., a radiofrequency identification (RFID) tag or strip, barcode, magnetic strip, color coding, or other label on a handle of a cleaning tool 24).

A handle of a cleaning tool 24 may be configured to enable identification of that cleaning tool 24 and to facilitate identification of an orientation of that cleaning tool 24.

FIG. 6A schematically illustrates fingers of a gripper of the cleaner robot shown in FIG. 1, prior to grasping a tool handle.

Tool handle 66 includes a tool label 68. Tool label 68 may be read or identified by an appropriate sensor 21, such as palm sensor 64, forward-looking imaging sensor 41, gripper-view imaging sensor 50, or another sensor. For example, tool label 68 may include an RFID tag or strip, barcode, magnetic strip, visual pattern (e.g., color coding, alphanumeric characters, pattern, or other pattern or distinctive marking that may be detected or imaged by an optical sensor in the visible, infrared, ultraviolet, or other spectral range), or another type of identifying labelling. Tool label 68 may, e.g., by identifying tool label 68 in an image that is acquired by an appropriate sensor 21 (e.g., forward-looking imaging sensor 41, gripper-view imaging sensor 50, RFID reader, magnetic sensor, or another sensor configured to acquire an image of tool handle 66 and of gripper 14) and identifying its orientation relative to gripper 14.

Tool label 68, e.g., in the form of an RFID label or two-dimensional barcode, may include encoded information about the attached cleaning tool 24. For example, encoded information may include an identifying model number or serial number of cleaning tool 24, a date of production, or other information. The encoded information may include a unique sequence that has been generated by a function (e.g., checksum, or MD5 algorithm) that may be used to validate that cleaning tool 24 has been manufactured properly by authorized manufacturer. For example, cleaning robot 10 may read the sequence, connect to a manufacturer or distributer of cleaning tool 24 (e.g., via a wireless network connection), and enable the contacted party to confirm the authenticity of cleaning tool 24.

Information that is retrieved using tool label 68 may enable assessment of cleaning tool 24 to determine its suitability for performing a cleaning task. For example, an image of cleaning tool 24 that is acquired by a sensor 21 may be compared with an image that is accessed via tool label 68 (e.g., a photograph that is provided by a manufacturer of cleaning tool 24). A comparison of the images may determine whether or not cleaning tool 24 is in good working order and sufficiently clean to be used for the cleaning task.

A grip delimiter of tool handle may have a slope that is configured to longitudinally center the tool handle when grasped by gripper 14.

Tool handle 66 may include one or more grip delimiters 69. In the example shown, each grip delimiter 69 is round. The round shape of grip delimiter 69 may guide a gripper 14 that is beginning to grip tool handle 66 toward the region of tool handle 66 between grip delimiters 69 (e.g., as in the example shown, where the uppermost gripper finger 62 is contacting the upper grip delimiter 69). For example, a surface of grip delimiter 69 may be made of a material that tends to slide when in contact with gripper fingers 60 or opposing gripper finger 61.

a Grip delimiter 69, or another part of tool handle 66, of each tool or type of tool may be marked with a unique visual pattern to be distinguishable from one another tool, e.g., to a sensor 21. The visual patterning or marking may also be indicative of an orientation of the tool handle. For example, different grip delimiters 69 may have different colors, or may be distinguished by their positions or orientations relative to an identifiable position on tool handle 66 (e.g., tool label 68), by differences in shape, or otherwise. Grip delimiters 69 may indicate ends of a region of tool handle 66 that is to be grasped by gripper 14 in order to most effectively manipulate cleaning tool 24 (e.g., with least risk of dropping a cleaning tool 24, enabling most effective cleaning using cleaning tool 24, or otherwise). The structure of the gripping tool allows error tolerance in the position of the gripper. Nevertheless, the tool will be adjusted and positioned correctly.

In some cases, one or more external tools that are not configured to be stored in a receptacle 22, e.g., a hose or handle of a vacuum cleaner, water hose, or other external tool, may be provided with a handle that includes one or more tool labels 68, grip delimiters 69, or other structure to facilitate manipulation and identification by cleaning robot 10. Control unit 20 (e.g., arm control unit 80) may be configured to move gripper 14 to the handle of the external tool, and to cause gripper 14 and robotic arm 12 to manipulate the handle of the external tool.

FIG. 6B schematically illustrates the fingers and tool handle of FIG. 6A, with the fingers closed onto the tool handle to grasp the tool handle.

Grip delimiters 69 may prevent longitudinal sliding of tool handle 66 when grasped by gripper 14.

FIG. 7 schematically illustrates a gripper of the cleaning robot of FIG. 1 holding a handle with pyramidal delimiters.

Tool handle 70 of a cleaning tool 24 includes pyramidal grip delimiters 72. Pyramidal grip delimiters 72 may indicate ends of a region of tool handle 70 that is to be grasped by gripper 14 in order to most effectively manipulate cleaning tool 24. The pyramidal shape of pyramidal grip delimiters 72 may guide a gripper 14 that is beginning to grip tool handle 70 toward the region of tool handle 70 between pyramidal grip delimiters 72. Pyramidal grip delimiters 72 may also prevent longitudinal sliding of tool handle 70 when grasped by gripper 14.

Pyramidal grip delimiters 72 may be configured to facilitate identification of an orientation of tool handle 70 using one or more sensors 21 of a cleaning robot 10. For example, one or more faces 72b may be provided with one or more features that enable distinguishing one face 72b from another. Different faces 72b may be differently colored or patterned, or otherwise marked. Identification of different faces 72b may enable unambiguous identification of each corner 72a where three faces meet and define both tool type and orientation. Corners 72a may be otherwise distinguishable from one another.

For example, images that are acquired concurrently by two or more sensors 21 (e.g., one or more of forward-looking imaging sensors 41, gripper-view imaging sensors 50, or other sensors 21), e.g., where the current position of each sensor 21 is known, may be analyzed to yield an orientation of tool handle 70 relative to gripper 14 (e.g., using standard techniques for calculation of absolute coordinates of corners 72a from image plane coordinates of each corner 72a in images acquired by each different sensor 21).

Handles may have otherwise shaped grip delimiters, combinations of differently shaped grip delimiters, or no grip delimiters. An orientation of a handle of a cleaning tool 24 may be otherwise determined (e.g., applying detection methods other than imaging).

In some cases, a handle of a cleaning tool 24 may be asymmetrically shaped so as to facilitate grasping the tool by a gripper 14 with a predetermined orientation.

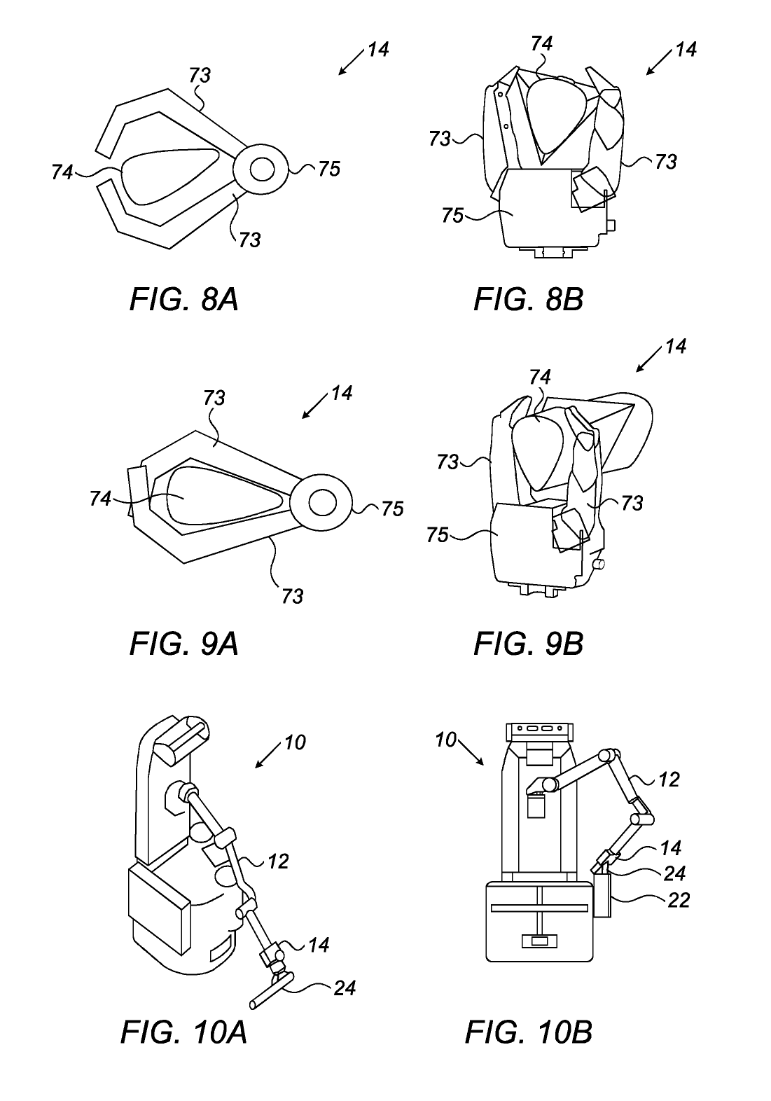

FIG. 8A is a schematic cross-sectional view of a gripper beginning to grasp a tool handle that is misaligned with the gripper. FIG. 8B is a schematic perspective view of a gripper beginning to grasp a tool handle that is misaligned with the gripper.

In the example shown, tool handle 74 has an asymmetric cross section similar to an egg shape. The wide end of the egg shape is configured to face distally outward when grasped by gripper 14. Each finger 73 of gripper 14 may rotate toward an opposite finger 73 about its proximal connection 75. The inward rotation of each finger 73 may apply a rotational torque on tool handle 74 to cause the narrow side of tool handle 74 to rotate toward proximal connection 75.

FIG. 9A is a schematic cross-sectional view of a gripper grasping a tool handle that is aligned with the gripper. FIG. 9B is a schematic perspective view of a gripper grasping a tool handle that is aligned with the gripper.

Tool handle 74 has rotated toward the desired orientation, with its wide side facing away from proximal connection 75 and its narrow side facing toward proximal connection 75. When in this position, fingers 73 may be locked or held in this position such that tool handle 74 is firmly held by gripper 14 and is prevented from further rotation about its axis.

Alternatively or in addition, a tool handle may be provided with one or more openings, cavities grooves, depressions, bosses, or other structure that assures alignment and or prevents rotation of a tool handle when grasped by gripper 14.

FIG. 10A schematically illustrates the cleaning robot of FIG. 1 grasping and manipulating a cleaning tool.

Robotic arm 12 may be manipulated when gripper 14 holds a cleaning tool 24 to perform a cleaning task. In the example shown, cleaning tool 24 is in the form of a mop or brush whose cleaning surface is being manipulated along a floor, e.g., by propulsion of cleaning robot 10 along the floor, or otherwise. A cleaning tool 24 may have another form or may be otherwise manipulated.

FIG. 10B schematically illustrates the cleaning robot of FIG. 1 accessing a cleaning tool in a receptacle.

Robotic arm 12 and gripper 14 may be manipulated to grasp and remove a cleaning tool 24 from a receptacle 22. Similarly, robotic arm 12 and gripper 14 may be manipulated to replace cleaning tool 24 in receptacle 22 and to release cleaning tool 24.

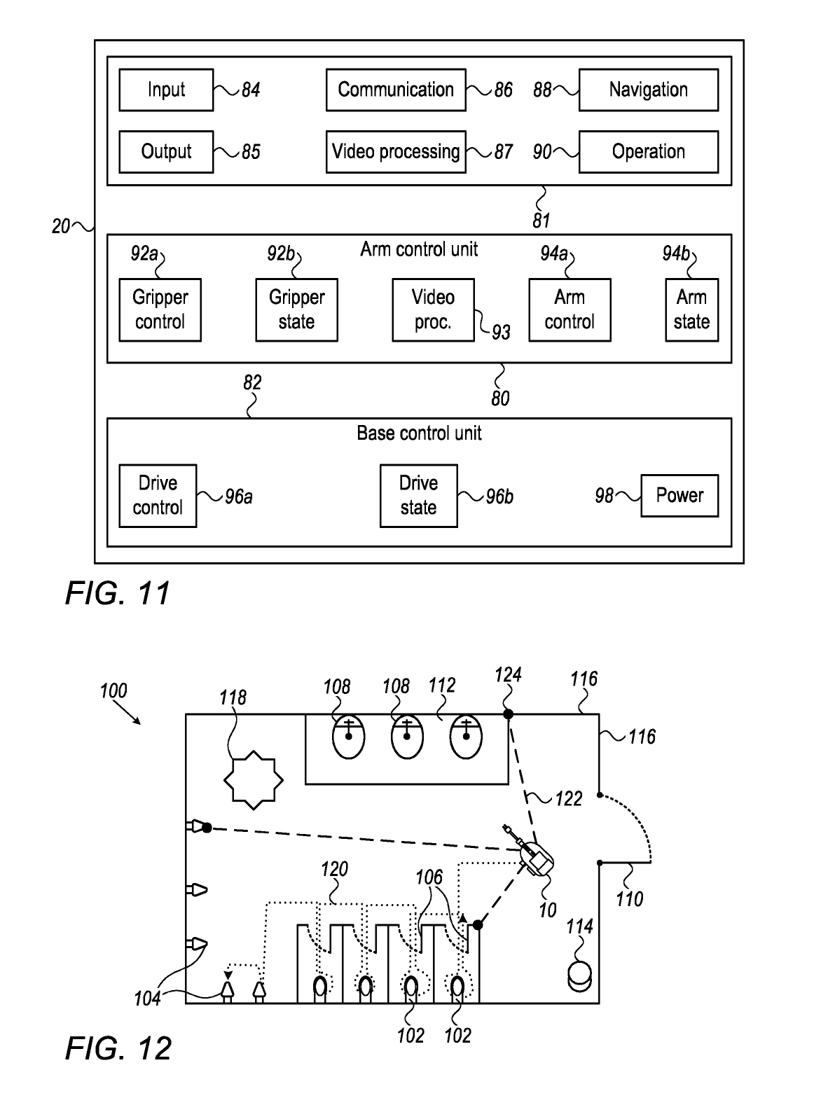

FIG. 11 is a schematic block diagram of an example of controller architecture for the cleaning robot shown in FIG. 1.

In the example shown, some of the functionality of control unit 20 is provided by two separate control units, arm control unit 80 and base control unit 82. For example, arm control unit 80 may include a processing unit or computer that is located in arm base 18. Similarly, base control unit 82 may include a processing unit or computer that is located in robot base 16. Remaining functionality may be provided by a processing unit 81, e.g., located within in control unit 20 or elsewhere.

In some cases, processing unit 81 may be configured to control operation of some or all other units, such an arm control unit 80, base control unit 82, or their subunits. Units and subunits of control unit 20 may intercommunicate via high-speed data busses. In some cases, one or more of arm control unit 80, base control unit 82, or their subunits may operate parallel and independently of one another, enabling concurrent performance of several tasks (e.g., propulsion of cleaning robot 10, operation of robotic arm 12, movement, communication, and other computations or operations).

In some cases, one or more units of processing unit 81, arm control unit 80, and base control unit 82 may include a data storage device, memory device, input device, output device, communications device, or other device that is dedicated to or is accessible by that unit only. In some cases, two or more of the units may share access to one or more of the devices.

Subunits of processing unit 81, arm control unit 80, and base control unit 82 may, in some cases, represent separate devices, hardware modules, or circuits, may represent software modules, or a combination of hardware and software modules. For example, subunits of processing unit 81 may, in some cases, represent high level software modules that perform high-level planning and resolution of conflicting input, e.g., including using CNN and DL. Subunits of arm control unit 80 and of base control unit 82 may, in some cases, represent drivers or controllers that translate high level commands and data into commands to specific motors or actuators. Such drivers or controllers, upon receiving a high-level command, may operate autonomously to perform a specific task, and may be configured to perform some closed-loop corrections on the basis of sensor input.

In the example shown, processing unit 81 is configured to receive input via input subunit 84 (e.g., in communication with one or more user controls 25). Processing unit 81 is also configured to generate output via output subunit 85 (e.g., in communication with one or more output devices 23). Processing unit 81 is also configured to communicate with an external device (e.g., remote control unit, a processor of a server or control station, or other external device) via communication subunit 84 (e.g., in communication with one or more antennas, connectors, transmitters, receivers, or other device that enables communication via a communications channel).

In the example shown, video processor subunit 87 is configured to receive and analyze data from one or more image acquisition of video sensors. For example, the video sensors may include one or more forward-looking imaging sensors 41, e.g., arranged on different sides of cleaning robot 10. In some cases, each of two or more video processor subunits 87 is configured to process imaging or video data from a single forward-looking imaging sensor 41 of two or more forward-looking imaging sensors 41.

In the example shown, processing unit 81 is configured to control movement and navigation of cleaning robot 10 via navigation subunit 88. For example, navigation subunit 88 may determine a current position of cleaning robot 10, e.g., on the basis of data received from one or more sensors 21. Navigation subunit 88 may calculate a direction of travel for cleaning robot 10, e.g., on the basis of stored or acquired data regarding a surrounding area, e.g., a lavatory facility that is to be cleaned. A determined direction of travel may be communicated to base control unit 82 to control operation of a propulsion system to move cleaning robot 10.

In the example shown, drive control subunit 96a of base control unit 82 is configured to control propulsion of cleaning robot 10, e.g., by controlling operation of a motor or transmission to drive one or more drive wheels 26. Control by drive control subunit 96a may be in accordance with instructions received from navigation subunit 88, and a state of robot base 16 or cleaning robot 10 as determined by drive state subunit 96b. For example, drive state subunit 96b may receive data from one on or more of an encoder that measures a rotation angle or velocity of drive wheel 26, an indication of motor operation (e.g., power consumption), one or more proximity or contact sensors of sensors 21 (e.g., located on robot base 16, e.g., configured to detect an immanent collision or collision that has already occurred), or other sensors 21.

In the example shown, power subunit 98 of base control unit 82 may monitor a power supply to cleaning robot 10, e.g., by monitoring a current charge or output voltage or current of a storage battery of cleaning robot 10. When power is determined to be low, power subunit 98 may communicate with navigation subunit 88 and operation subunit 90 to cause cleaning robot 10 to proceed to a charging station or wall socket to recharge the storage battery, e.g., via charging connection 28.

In the example shown, processing unit 81 is configured to control operation of cleaning robot 10 via operation subunit 90. For example, operation subunit 90 may determine one or more cleaning tasks or other tasks that are to be performed by cleaning robot 10. The determination may include evaluation of current conditions that relate to operation of cleaning robot 10, e.g., on the basis of data that is sensed by one more sensors 21. For example, operation subunit 90 may evaluate a condition of a surface or fixture that is to be cleaned or that was cleaned, may detect an object that is to be moved or removed, may select a cleaning tool 24 or receptacle 22 that is to be utilized in performing a task, and may determine an action that is to be performed by robotic arm 12. Information regarding an action that is to be performed may be communicated to arm control unit 80 to control operation of robotic arm 12 and of gripper 14.

In the example shown, arm control unit 80 is configured to control operation of gripper 14 and of robotic arm 12.

In the example shown, video processing subunit 93 of arm control unit 80 is configured to receive and analyze data from one or more image acquisition of video sensors that are related to operation of robotic arm 12. For example, the video sensors may include one or more gripper-view imaging sensors 50, or another video or imaging sensor configured to monitor operation of robotic arm 12 or of gripper 14.

For example, gripper control subunit 92a of arm control unit 80 may be configured to control operation of gripper 14, e.g., by controlling one or more actuators of gripper 14. Control via gripper control subunit 92a may be based on received instructions, e.g., from operation subunit 90, and on a current state of gripper 14 as determined via gripper state subunit 92b. Gripper state subunit 92b may determine a current state of gripper 14 on the basis of one or more sensors 21, e.g., a force or proximity as measured by a finger contact sensor 62, an identification as determined via a palm sensor 64, one or more encoders that sense a current bending of each joint between jointed finger segments 65, a gripper-view imaging sensor 50, or another sensor.

Similarly, arm control subunit 94a of arm control unit 80 may be configured to control operation of robotic arm 12, e.g., by controlling one or more motors or actuators of robotic arm 12. Control via arm control subunit 94a may be based on instructions received, e.g., from operation subunit 90, and on a current state of robotic arm 12 as determined via arm state subunit 94b. Arm state subunit 94b may determine a current state of robotic arm 12 on the basis of one or more sensors 21, e.g., an encoder that measures a bending angle of an arm joint 34, an encoder that measures a rotation at a rotatable arm joint 33 or at arm connection 35, by a proximity or contact sensor, or another sensor.

FIG. 12 schematic illustrates planning a path for cleaning lavatory facilities by the cleaning robot shown in FIG. 1.

In the example shown, room 100 represents a lavatory facility. Room 100 is bounded by walls 116 and includes room door 110. Cleaning robot 10 is initially within room 100 and has been commanded to clean toilets 102 and urinals 104. Additional fixtures and objects within room 100 may include wastebasket 114 and counter 112 with sinks 108. A path that is optimized for time or quality could be predefined in advance, e.g., in accordance with cleaning requirements.

In some cases, operation of cleaning robot 10 within a room 100 may require limitations with regard to room 100. For example, operation of cleaning robot 10 may require that room 100 has a flat floor with no large steps or discontinuities (e.g., no steps larger than about 5 cm). Doors within room 100 may be suitable for opening and closing by operation by gripper 14. Toilet lids and seats, flushing buttons or levers, may have structure that facilitates operation by gripper 14 and robotic arm 12.

A toilet lid may be designed, e.g., with special adjustments or small handles to facilitate lifting of the lid by robotic arm 12.

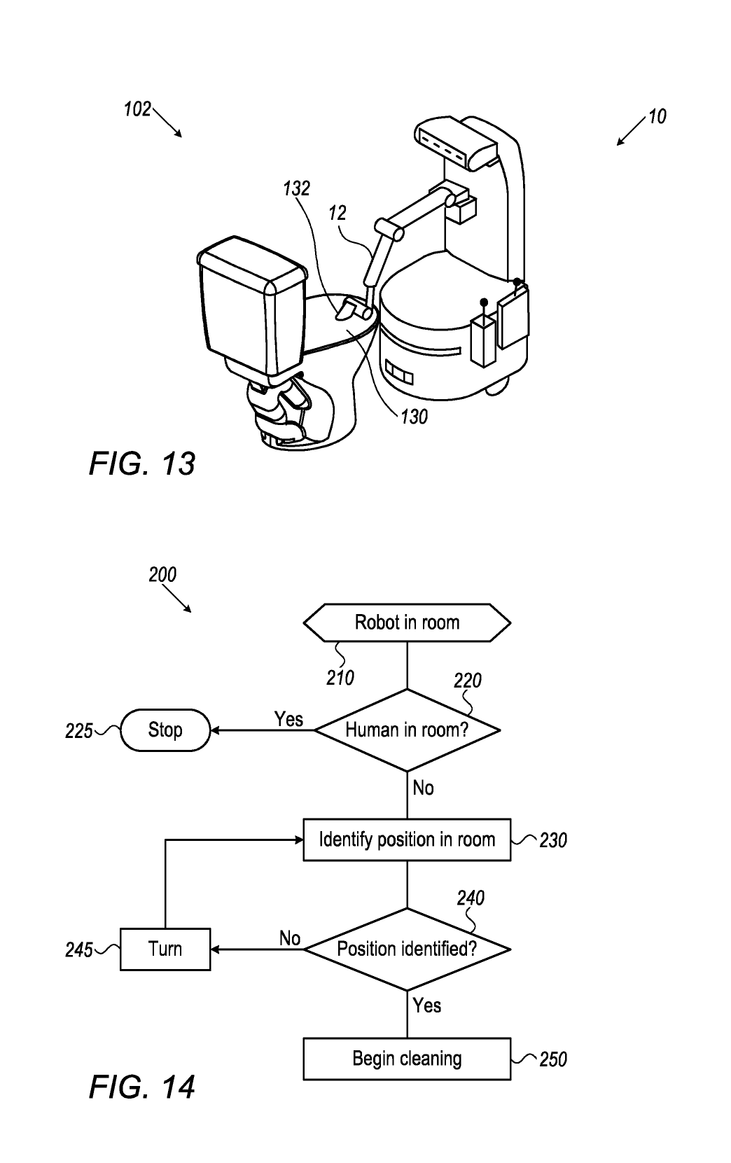

FIG. 13 schematically illustrates a toilet lid that is configured for operation by the cleaning robot shown in FIG. 1.

In the example shown, toilet 102 includes a toilet lid 130 that is provided with lid handle 132. Cleaning robot 10 may manipulate robotic arm 12 and gripper 14 to manipulate lid handle 132 to open toilet lid 130. The interface could be magnetic or another type of interface.

A three-dimensional plan of room 100 may be constructed and stored for access by control unit 20 of cleaning robot 10. For example, the plan may be constructed based on input (e.g., of an architectural or other room plan) by an operator of cleaning robot 10, on input based on results of scanning of room 100 by one or more sensors 21 of cleaning robot 10 (e.g., when first placed in a particular room 100), or both. The three-dimensional plan may include one or more reference points 124 that may be identified by control unit 20 based on prominent or distinctive visual structures (e.g., corners, textures, or edges).

In some cases, e.g., during initializing cleaning robot 10 for operation in room 100, an operator may prepare a detailed map of room 100 on which are marked actual size of the objects, doors, and mirrors, and may prepare a rough grid (e.g., with a resolution of about 0.5 m), and may mark special positions on a position grid (e.g., at locations near fixtures that are to be cleaned, or otherwise). Cleaning robot 10 may then be placed in room 100 and operated in a mapping mode. When in the mapping mode, cleaning robot 10 may be configured to move to points of the grid, including the marked special positions. At each point, cleaning robot 10, or one or more sensors 21 of cleaning robot 10, may perform a 360° scan. At positions where relevant, separate scans may be performed with doors and fixtures in both open and closed positions. During each scan, control unit 20 may collect information such as accurate (e.g., to within 1 cm) positions and shapes of objects and fixtures, positions of mirrors, opening directions and hinge positions of doors, gaps between a door and the floor, shapes and positions (and their operation) of handles and locks of doors, types of flushing mechanisms (e.g., buttons or levers) and their operation, images of doors and toilet lids and seats when both open and closed (e.g., to facilitate recognition of a state of such a door, lid, or seat), or other information.

Upon receiving a command (e.g., via one or both of communication subunit 86 or input subunit 84) to clean room 100, navigation subunit 88 may operate one or more sensors 21, e.g., forward-looking imaging sensors 41 or other sensors, of cleaning robot 10 to detect a plurality of reference points 124. For example, a reference point 124 may represent a fiducial or other marker that was placed at a known point within room 100 for use by cleaning robot 10 in navigation. In other cases, reference point 124 may represent an identifiable feature or landmark (e.g., a corner where two walls or surfaces meet, or an identifiable fixture) in room 100. In measuring a distance to a reference point 124, navigation subunit 88 may be configured to recognize any mirrors (e.g., by imaging in different spectral bands, or by recognizing a left/right transformation of the room or otherwise), or to ignore the effects of mirrors that are indicated in a retrieve plan of room 100.

A length and orientation of a line 122 between cleaning robot 10 and each reference point 124 may be measured (e.g., using a rangefinder or range-finding capability of sensors 21). Navigation subunit 88 may then calculate a position of cleaning robot 10 within a plan that is accessible by navigation subunit 88.

In addition, a region of room 100 may be marked as a warning area 118. For example, a human operator of cleaning robot 10 may indicate part of room 100 as warning area 118 on the basis of visual inspection of room 100, either directly or by monitoring data that was generated by sensors 21 of cleaning robot 10.

Navigation subunit 88 may plan a cleaning path 120 that cleaning robot 10 is to move along. For example, navigation subunit 88 may be configured to calculate a shortest or most efficient (e.g., with regard to energy, time, tool use, or another criterion) path for performing the commanded tasks. Cleaning path 120 may be configured to avoid travelling through any warning areas 118, to avoid areas that have already been cleaned, or in accordance with other criteria.

When cleaning robot 10 is traveling along cleaning path 120 or operating, navigation subunit 88 may continue to monitor reference points 124 and lines 122 to detect small position errors and to enable adjustment of movement of cleaning robot 10 or operation of robotic arm 12.

As cleaning robot 10 travels along cleaning path 120, navigation subunit 88 or operation subunit 90 may receive input from one or more sensors 21 regarding a status of one or more objects or structures along cleaning path 120. For example, if a toilet stall door 106 is detected to be closed or partially opened (e.g., by measuring an orientation of toilet stall door 106), operation subunit 90 may operate robotic arm 12 or may move cleaning robot 10 to open that toilet stall door 106. If toilet stall door 106 is locked, cleaning robot 10 may be configured to wait until the door opens or to unlock a locking mechanism of toilet stall door 106. In some cases, upon encountering a locked toilet stall door 106, cleaning robot 10 may be configured to proceed to another point along cleaning path 120 and return to the locked toilet stall door 106 at a later time, e.g., after toilet stall door 106 is unlocked or opened.

If sensors 21 indicate that a lid or toilet seat of a toilet 102 is closed, operation subunit 90 may operate robotic arm 12 and gripper 14 to raise the lid or seat. Once the lid or seat is raised, operation subunit 90 may operate robotic arm 12 and gripper 14 to manipulate an appropriate cleaning tool 24 to clean toilet 102. After the cleaning operation, gripper-view imaging sensor 50 may proceed along cleaning path 120 to the next fixture to be cleaned.

In some cases, navigation subunit 88, operation subunit 90, or another unit of processing unit 81 or control unit 20 may be configured to learn to recognize an object or configuration of an object. For example, deep neural network techniques may be applied to enable control unit 20 to distinguish different types and configurations of objects or fixtures, or to create a map of a region.

Navigation subunit 88, operation subunit 90, or another unit of processing unit 81 or control unit 20 may be configured to apply various pedestrian and face detection techniques or motion detection techniques to input from sensors 21 to detect the presence of any people within room 100. Once the presence of a person is detected, the location of the person may be labeled as a warning area 118, or operation of cleaning robot 10 may be halted or paused, until the person leaves room 100. A motion detector may be configured to distinguish between motion of an external object and motion by a sensor 21 on cleaning robot 10.

Operation subunit 90 may be configured to analyze data from sensors 21 to assess whether cleaning of that surface was effective. For example, an image that is acquired of a surface after cleaning may be compared to a reference image, e.g., retrieved from a database of surface images. When cleaning is determined to be ineffective, communication subunit 86 or output subunit 85 may be operated to inform a human operator.

Operation subunit 90 may be configured to detect insufficient illumination in a room 100. For example, an imaging sensor of sensors 21 may measure the brightness or color of a reference surface (e.g., a surface of cleaning robot 10 or another surface). When the illumination is detected to be insufficient for operation of cleaning robot 10 (e.g., cannot identify objects or surfaces, evaluate surface quality, or otherwise adversely affect function of cleaning robot 10), cleaning robot 10 may do one or more of abort or pause operation in room 100 (e.g., proceed to a different room), operate an illuminating lamp of cleaning robot 10 (if available) to provide sufficient illumination, inform a human operator, or perform another action.

A human operator, e.g., operating a remote control station or device (e.g., via an application on a smartphone or portable computer), may monitor and intervene in operation of cleaning robot 10. For example, the operator may monitor audio and video input to various sensors of cleaning robot 10, may monitor a position of cleaning robot 10 in room 100, may monitor a position or status of robotic arm 12, may note locations where human assistance or intervention is required, may monitor power levels of storage batteries, may monitor quality of cleaning tools 24, or may monitor other aspects of cleaning robot 10 or its operation. The operator may remotely operate cleaning robot 10 and robotic arm 12, may initiate a self-check procedure, may create or modify a plan or map of a room 100, may create or modify a plan for a cleaning procedure in a room 100 (e.g., how often, which types of cleaning motions, which cleaning tools 24 to use, or other aspects of cleaning a room 100), or otherwise operate cleaning robot 10. The operator may access a database that stores and logs information recorded during operation of one or more cleaning robots 10.

For example, a room scanning process may be performed by movement of cleaning robot 10 inside a room while in a recording mode. When in the recording mode, information from various sensors 21 may be recorded along with coordinates of cleaning robot 10 and any user inputs.

Cleaning robot 10 may be configured to enable an operator to manually guide cleaning robot 10, e.g., from one room 100 to another. For example, the operator may operate a user control 25 to place cleaning robot 10 in a moving mode. In some cases, when in a moving mode, drive wheels 26 may be disconnected (e.g., by turning off a drive motor or by operating a clutch to disable a transmission) such that cleaning robot 10 may be pushed or pulled by a human operator (e.g., by pushing or pulling on an appropriate handle). In some cases, a pull or push on one or more handles of cleaning robot 10 may be sensed by control unit 20. Control unit 20, e.g. drive control subunit 96a, may then turn drive wheels 26 in a direction indicated by the sensed push or pull. In some cases, control unit 20, e.g. drive control subunit 96a, may also operate a propulsion system of cleaning robot 10 to turn drive wheels 26 in a direction indicated by the sensed push or pull.

Control unit 20 may be configured to execute a method for cleaning a room 100.

FIG. 14 is a flowchart depicting a method for cleaning by a cleaning robot, in accordance with an embodiment of the present invention.

It should be understood, with respect to any flowchart referenced herein, that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Cleaning method 200 may be executed by control unit 20 of cleaning robot 10 when cleaning robot 10 is placed in a room 100 which is to be cleaned, or where cleaning is to take place (block 210). Cleaning robot 10 may be prepared for operation by cleaning each cleaning tool 24 and receptacle 22, filling each receptacle 22 with any relevant detergent substances, and any other preparation. An operator may also close and mark an entrance door to room 100, e.g., to prevent people from entering room 100. The operator may also initiate execution of cleaning method 200, e.g., by operating a user control 25, or by operating a remote device.

Cleaning robot 10 may operate one or more sensors 21 (e.g., a motion, thermal, or imaging sensor) to determine if there are any people in room 100 (block 22).

If a human presence is detected, cleaning robot 10 may stop operation (block 225). In some cases, cleaning robot 10 may pause operation (e.g., pause movement or propulsion of cleaning robot 10 or movement of robotic arm 12) until no more people are detected.

If no human presence is detected for a predetermined period of time (e.g., 30 seconds, or another period of time), control unit 20 may attempt to identify a position of cleaning robot 10 in room 100 (block 230). For example, one or more sensors 21 may be operated to identify and measure a distance to a plurality of reference points 124.

If identification of the position fails (block 240), cleaning robot 10 may be operated to turn through a predetermined rotation angle, e.g., about 30° or another angle (block 245). Control unit 20 may then repeat the attempt to identify the position (block 230). A predetermined number (e.g., 3, or another number) of attempts to identify the position may be repeated before timing out (e.g., and calling for human assistance).

In some cases, cleaning robot 10 may be subjected to forces that may flip it over. Such forces may result from human vandalism, an algorithm error, a changing environment, or another cause. These forces may act on robotic arm 12 or on another part of cleaning robot 10. Cleaning robot 10 may detect a change in inclination using accelerometers of control unit 20. When the inclination exceeds a predetermined angle, cleaning robot 10 may react to prevent falling. For example, cleaning robot 10 may operate robotic arm 12 and drive wheels 26 (e.g., in the direction of the fall) to shift the center of gravity of cleaning robot 10 to a point above robot base 16.

If identification of the position is successful (block 240), cleaning robot 10 may begin cleaning (block 250).

For example, control unit 20 may control cleaning robot 10 to travel along cleaning path 120. When cleaning robot 10 identifies that it has reached a predefined landmark along cleaning path 120 (e.g., a fixture to be cleaned, such as a toilet 102 or urinal 104), cleaning robot 10 may begin a cleaning sequence.

If an obstacle is identified along cleaning path 120, control unit 20 may cause cleaning robot 10 to maintain a predetermined distance from the obstacle. In some cases, cleaning robot 10 may be controlled to travel around the obstacle.

For example, the cleaning sequence may include cleaning a toilet 102. When cleaning robot 10 approaches toilet 102, control unit 20 may control cleaning robot 10 to enter toilet stall door 106, opening a door when necessary, and to move to within a predetermined distance from toilet 102. Robotic arm 12 may (e.g., after lifting a toilet seat when found to be lowered) remove an appropriate cleaning tool 24 (e.g., a brush tool) from its receptacle 22, apply that cleaning tool 24 to the bowl of toilet 102, and return cleaning tool 24 to its receptacle 22. One or more sensors 21 of cleaning robot 10 may verify cleanliness. Robotic arm 12 may then lower the toilet seat, and using an appropriate cleaning tool 24, clean the seat. Robotic arm 12 may then be controlled to flush toilet 102. Cleaning robot 10 may then exit via toilet stall door 106, opening if necessary, and proceed along cleaning path 120.

As another example, the cleaning sequence may include mopping a floor of room 100. In this case, cleaning robot 10 may remove a cleaning tool 24 in the form of a mop from its receptacle 22. The cleaning end of that cleaning tool 24 may be placed on the floor and pulled or pushed along an appropriate cleaning path. In some cases, a cleaning path may be optimized for one or more of minimizing cleaning time or energy, avoiding travel through areas that were already cleaned, or may be designed with respect to other criteria. Walls 116, counter 120, or sinks 108 may be cleaned by causing cleaning robot 10 to travel along the surfaces to be cleaned and by operating robotic arm 12 with an appropriate cleaning tool 24 to use the cleaning tool 24 to clean the surface. When necessary, e.g., at predetermined intervals or when inspection of cleaning tool 24 is so indicative, a cleaning tool 24 may be returned to its receptacle 22 in order to refresh that cleaning tool 24 with a cleaning substance in receptacle 22.

When picking up garbage, control unit 20 may be configured to cause cleaning robot 10 to travel along a predetermined cleaning path 120, identify objects on the floor or elsewhere that may be lifted, lift an object that is identified as garbage, move the lifted object to a predetermined collection location (e.g., wastebasket 114 or to another location), return to the location of cleaning robot 10 prior to lifting the object, and continue travelling along cleaning path 120 form the point where the garbage was lifted.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A cleaning robot comprising:
a propulsion mechanism to propel the robot on a floor;
a robotic arm;
a gripper at a distal end of the robotic arm;
a plurality of different cleaning tools, each cleaning tool including a handle that is configured to be grasped by the gripper;
a plurality of receptacles, at least one of the receptacles configured to hold a cleaning tool of said plurality of cleaning tools; and
a controller configured to:
autonomously operate the propulsion system to transport the robot to region to be cleaned;
operate the robotic arm to bring the gripper to a receptacle of said plurality of receptacles that is holding a selected cleaning tool of said plurality of cleaning tools;
operate the gripper to grasp a handle of the selected cleaning tool and to manipulate the cleaning tool when cleaning the region; and
operate the robotic arm and the gripper to return the selected cleaning tool to that receptacle.

2. The cleaning robot of claim 1, wherein the handle is configured to self-align with the gripper when grasped by the gripper.

3. The cleaning robot of claim 2, wherein the handle has an asymmetric cross section.

4. The cleaning robot of claim 2, wherein a grip delimiter of the handle is sloped so as to longitudinally center the handle when grasped by the gripper.

5. The cleaning robot of claim 1, wherein a tool of said plurality of cleaning tools comprises an identifying label.

6. The cleaning robot of claim 5, wherein the identifying label comprises an RFID tag, a magnetic strip, barcode, or a visual pattern.

7. The cleaning robot of claim 5, wherein the gripper comprises a sensor configured to read the identifying label.

8. The cleaning robot of claim 1, wherein the handle of a cleaning tool of said plurality of cleaning tools is uniquely marked with a marking that is distinguishable by an imaging sensor.

9. The cleaning robot of claim 8, wherein the distinguishable marking is indicative of an orientation of that cleaning tool.

10. The cleaning robot of claim 1, further comprising a plurality of fixed imaging sensors whose fields of view are aimed in different directions.

11. The cleaning robot of claim 10, wherein said at least two fixed imaging sensors of said plurality of fixed imaging sensors have overlapping fields of view.

12. The cleaning robot of claim 1, further comprising an imaging sensor that is placed on the gripper or on the robotic arm.

13. The cleaning robot of claim 1, wherein the gripper comprises a finger with a contact sensor to detect contact of the finger with a surface.

14. The cleaning robot of claim 1, wherein the controller is further configured to modify operation of the cleaning robot when the presence of a person is detected.

15. The cleaning robot of claim 14, wherein the controller is further configured to pause propulsion of the cleaning robot or operation of the robotic arm while the presence of the person is detected.

16. The cleaning robot of claim 1, wherein a receptacle of said plurality of receptacles is configured to hold a cleaning fluid.

17. The cleaning robot of claim 1, wherein the controller is further configured to utilize a sensor measurement to compensate for an error in motion of the robotic arm.

18. The cleaning robot of claim 1, wherein the controller is configured to operate the cleaning robot in accordance with a stored computer aided design (CAD) map of a region.

19. The cleaning robot of claim 1, wherein the controller is further configured to operate the robotic arm to bring the gripper to an external tool that is not held in said plurality of cleaning receptacles and to operate the gripper to grasp a handle of the external tool and to manipulate the external tool to clean the region.

20. The cleaning robot of claim 1, wherein the controller is further configured to apply deep learning to sensor data in order to create a map of a region or to calculate an optimum path for propulsion or for operation of the robotic arm.
